(19) United States
(12) Patent Application Publication
(10) Pub. No.: US 2020/0232325 A1
(43) Pub. Date: Jul. 23, 2020

(54) VARIABLE OPERATION SYSTEM FOR INTERNAL COMBUSTION ENGINE, AND CONTROL DEVICE THEREFOR

(71) Applicant: HITACHI AUTOMOTIVE SYSTEMS, LTD., Hitachinaka-shi, Ibaraki (JP)

(72) Inventor: Makoto NAKAMURA, Zushi-shi, Kanagawa (JP)

(73) Assignee: HITACHI AUTOMOTIVE SYSTEMS, LTD., Hitachinaka-shi, Ibaraki (JP)

(21) Appl. No.: 16/634,496

(22) PCT Filed: Jul. 20, 2018
(86) PCT No.: PCT/JP2018/027210

§ 371 Date: Jan. 27, 2020

(30) Foreign Application Priority Data
Aug. 14, 2017 (JP) 2017-156335

(51) Int. Cl. F01B 31/14; F02B 75/04; F02D 15/02; F02D 13/02; F02D 41/06

(52) U.S. Cl. CPC F01B 31/14; F02B 75/04; F02D 43/00; F02D 13/0207; F02D 41/064; F02D 15/02

(57) ABSTRACT

An internal combustion engine variable operation system includes: an intake-side variable valve mechanism for controlling an opening timing and a closing timing of an intake valve of an internal combustion engine; an exhaust-side variable valve mechanism for controlling an opening timing and a closing timing of an exhaust valve of the internal combustion engine. At a cold start of the internal combustion engine, the exhaust-side variable valve mechanism sets the opening timing of the exhaust valve advanced at or close to a midpoint between top dead center and bottom dead center, and sets the closing timing of the exhaust valve advanced at a first preset advance-side point before top dead center, and the intake-side variable valve mechanism sets the opening timing of the intake valve retarded at a first preset retard-side point after top dead center.

### TECHNICAL FIELD

The present invention relates generally to a variable operation system for an internal combustion engine, and particularly to a variable operation system for an internal combustion engine provided with at least a variable valve mechanism for controlling valve timing of an exhaust valve set and an intake valve set, and a control device for the internal combustion engine variable operation system.

### BACKGROUND ART

For modern internal combustion engines, it has been proposed to improve performance of an internal combustion engine by a combination of a variable compression ratio mechanism and a variable valve mechanism, wherein the variable compression ratio mechanism controls variably a geometric compression ratio and a geometric expansion ratio of the internal combustion engine, namely, a mechanical compression ratio and a mechanical expansion ratio of the internal combustion engine, and wherein the variable valve mechanism controls variably valve timing (opening and closing timings) of an intake valve and an exhaust valve, on which an actual compression ratio (effective compression ratio) of the internal combustion engine depends. JP 2002-276446 A (patent document 1) discloses such a known variable compression ratio mechanism.

A document “CO₂-Potential of a Two-Stage VCR System in Combination with Future Gasoline Powertrains” (non-patent document 1) shows in FIGS. 13 and 14 a mechanical compression ratio map, which sets a mechanical compression ratio to increase as a load decreases. As the load decreases, the mechanical compression ratio can be set higher, because the occurrence of problematic knocking is suppressed as the load decreases. Accordingly, a mechanical expansion ratio (=mechanical compression ratio) can be set higher, resulting in an increase in thermal efficiency of the internal combustion engine. Therefore, also at start of the internal combustion engine, the mechanical compression ratio is equal or close to a maximum mechanical compression ratio point (=maximum mechanical expansion ratio point). The operation of setting the mechanical compression ratio high at engine start serves to increase a temperature at compression top dead center, and thereby improve combustion at engine start, and achieve preferable startability.

### PRIOR ART DOCUMENT(S)

### Patent Document(s)

Patent Document 1: JP 2002-276446 A

### Non-Patent Document(s)

Non-Patent Document 1: “CO₂-Potential of a Two-Stage VCR System in Combination with Future Gasoline Powertrains”, 33rd International Vienna Motor Symposium 26-27 Apr. 2012

### SUMMARY OF INVENTION

### Problem(s) to be Solved by the Invention

According to non-patent document 1, at cold start of the internal combustion engine, the mechanical compression ratio is set to the maximum mechanical compression ratio point, and the mechanical expansion ratio is also set to the maximum mechanical expansion ratio point. This causes a phenomenon that the temperature of exhaust gas of the internal combustion engine falls. This suppresses an exhaust gas purifying catalyst, which is provided in an exhaust pipe, from being warmed up, and thereby causes a decrease in conversion ratio in the exhaust gas purification catalyst for adverse components of exhaust gas. This causes a problematic increase in quantity of adverse components of exhaust gas that is exhausted through a tail pipe to the atmosphere after passing through the exhaust gas purifying catalyst. Similar problems have arisen also with internal combustion engines provided with no variable compression ratio mechanism, because the mechanical expansion ratio εE (=mechanical compression ratio εC) tends to be increased for satisfying a demand for suppressing fuel consumption.

It is an object of the present invention to provide a new variable operation system for an internal combustion engine, and a control device for the variable operation system, which are capable of promoting the progress of warming-up of an exhaust gas purifying catalyst by raising the temperature of exhaust gas at cold start of the internal combustion engine.

### Means for Solving the Problem(s)

An embodiment of the present invention includes: an intake-side variable valve mechanism structured to control a phase of opening and closing timings of an intake valve; and an exhaust-side variable valve mechanism structured to control a phase of opening and closing timings of an exhaust valve; wherein at an engine cold start, the exhaust-side variable valve mechanism sets the opening timing of the exhaust valve advanced at or close to a midpoint between top dead center and bottom dead center, and sets the closing timing of the exhaust valve advanced at a preset point before top dead center, and the intake-side variable valve mechanism sets the opening timing of the intake valve retarded at a preset point after top dead center.

### Effect(s) of the Invention

According to a preferable embodiment of the present invention, even when the mechanical expansion ratio of the internal combustion engine is set to a high mechanical expansion ratio point, it is possible to increase the temperature of exhaust gas exiting from a combustion chamber by a sufficient advance of the opening timing of the exhaust valve at engine start, and thereby quickly warm up and increase the conversion ratio of an exhaust gas purifying catalyst arranged downstream of the combustion chamber.

Specifically, the operation of opening the exhaust valve when the temperature of combustion gas is still high after combustion, serves to exhaust hot exhaust gas and particularly exhaust hot exhaust gas swiftly under high pressure because the exhaust valve is opened under a condition that the in-cylinder pressure is high, and thereby further enhance the activity of the exhaust gas purification catalyst, and significantly reduce the adverse components of exhaust gas when the internal combustion engine is in cold state.

### BRIEF DESCRIPTION OF DRAWINGS

FIG. 1 is an overall schematic diagram of a variable operation system of an internal combustion engine according to the present invention.

FIG. 2A is a configuration diagram showing configuration of a variable compression ratio mechanism employed by the present invention in a state that a mechanical compression ratio is controlled to a minimum mechanical compression ratio point.

FIG. 2B is a configuration diagram showing configuration of the variable compression ratio mechanism employed by the present invention in a state that the mechanical compression ratio is controlled to a maximum mechanical compression ratio point.

FIG. 3A is an explanatory diagram illustrating valve characteristics of intake and exhaust valves with a “positive valve overlap” at a normal mechanical expansion ratio point (εE=12).

FIG. 3B is an explanatory diagram illustrating valve characteristics of the intake and exhaust valves with a “positive valve overlap” at a high mechanical expansion ratio point (εE=18).

FIG. 3C is an explanatory diagram illustrating valve characteristics of the intake and exhaust valves with a “negative valve overlap” at the high mechanical expansion ratio point (εE=18).

FIG. 4A is an explanatory diagram illustrating valve characteristics of intake and exhaust valves of a variable operation system of an internal combustion engine according to a first embodiment of the present invention at cold start of the internal combustion engine.

FIG. 4B is an explanatory diagram illustrating valve characteristics of the intake and exhaust valves of the variable operation system of the internal combustion engine according to the first embodiment of the present invention immediately before warming-up of the internal combustion engine is completed.

FIG. 4C is an explanatory diagram illustrating valve characteristics of the intake and exhaust valves of the variable operation system of the internal combustion engine according to the first embodiment of the present invention when the internal combustion engine is in a low load region after the warming-up.

FIG. 4D is an explanatory diagram illustrating valve characteristics of the intake and exhaust valves of the variable operation system of the internal combustion engine according to the first embodiment of the present invention when the internal combustion engine is in a high load region after the warming-up.

FIG. 5 is an explanatory diagram illustrating how opening and closing timings of the exhaust valves, opening and closing timings of the intake valves, and the mechanical expansion ratio change with time in the variable operation system of the internal combustion engine according to the first embodiment of the present invention.

FIG. 6 is a flowchart for performing a control for a condition that the variable operation system of the internal combustion engine according to the first embodiment of the present invention is stopped.

FIG. 7A is a flowchart showing a first half of a control flow for performing a control for a condition from engine start to the high load region with the variable operation system of the internal combustion engine according to the first embodiment of the present invention.

FIG. 7B is a flowchart showing a second half of the control flow for performing the control for the condition from engine start to the high load region with the variable operation system of the internal combustion engine according to the first embodiment of the present invention.

FIG. 8A is an explanatory diagram illustrating valve characteristics of intake and exhaust valves of a variable operation system of an internal combustion engine according to a second embodiment of the present invention at cold start of the internal combustion engine.

FIG. 8B is an explanatory diagram illustrating valve characteristics of the intake and exhaust valves of the variable operation system of the internal combustion engine according to the second embodiment of the present invention immediately before warming-up of the internal combustion engine is completed.

FIG. 8C is an explanatory diagram illustrating valve characteristics of the intake and exhaust valves of the variable operation system of the internal combustion engine according to the second embodiment of the present invention when the internal combustion engine is in a low load region after the warming-up.

FIG. 8D is an explanatory diagram illustrating valve characteristics of the intake and exhaust valves of the variable operation system of the internal combustion engine according to the second embodiment of the present invention when the internal combustion engine is in a high load region after the warming-up.

### MODE(S) FOR CARRYING OUT INVENTION

The following describes embodiments of the present invention in detail with reference to the drawings. However, the present invention is not limited to the embodiments, but contains in its scope various modifications and applications based on a technical concept of the present invention.

### First Embodiment

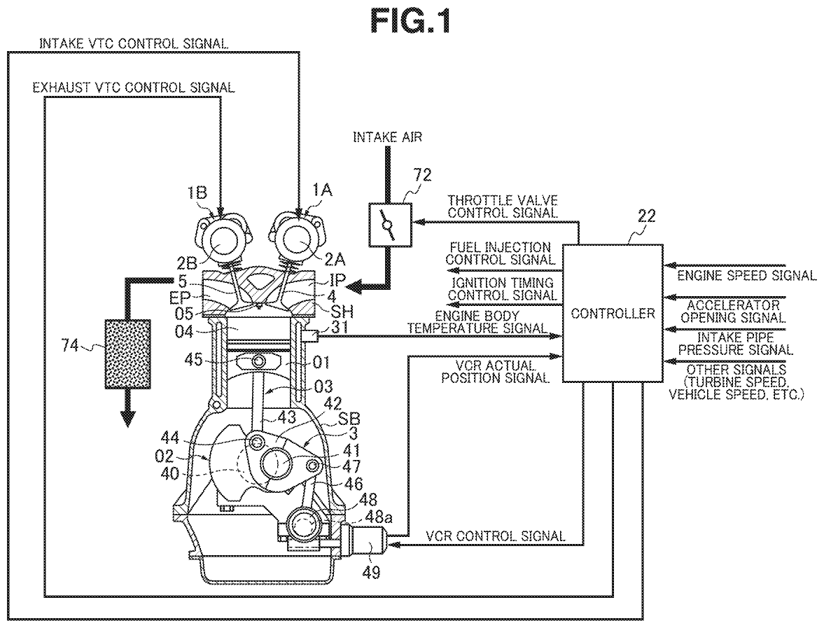

The following describes a variable operation system of an internal combustion engine according to a first embodiment of the present invention. FIG. 1 shows overall configuration of the variable operation system of the internal combustion engine to which the present invention is applied.

First, the following describes basic configuration of the variable operation system of the internal combustion engine with reference to FIG. 1. The variable operation system includes: a piston 01 mounted in a cylinder bore formed in a cylinder block SB for upward and downward slide by receipt of combustion pressure and others; an intake port IP and an exhaust port EP formed in a cylinder head SH; and a pair of intake valves 4 and a pair of exhaust valves 5 per cylinder mounted slidably in cylinder head SH, and structured to open and close open ends of intake port IP and exhaust port EP.

Piston 01 is linked to a crankshaft 02 via a connecting rod mechanism 03, and includes a crown face defining a combustion chamber 04 between the crown face and a lower face of cylinder head SH, wherein connecting rod mechanism 03 includes a lower link 42 and an upper link 43 described below. At a substantially central portion of cylinder head SH, an ignition plug 05 is provided.

Intake port IP is connected to an air cleaner not shown, and is supplied with intake air through an electrically controlled throttle valve 72. Electrically controlled throttle valve 72 is controlled by a controller 22, wherein the opening of electronic throttle valve 72 is controlled basically in accordance with an amount of depression of an accelerator pedal. Exhaust port EP releases exhaust gas through an exhaust gas purification catalyst 74 and through a tail pipe to the atmosphere.

As shown in FIG. 1, the internal combustion engine is further provided with an intake-side variable valve mechanism for controlling opening characteristics of intake valves 4, an exhaust-side variable valve mechanism for controlling opening characteristics of exhaust valves 5, and a variable compression ratio mechanism for controlling position characteristics of the piston.

The intake side is provided with intake-side variable valve mechanism (henceforth referred to as intake-side VTC mechanism) 1A as a “phase angle varying mechanism” structured to control a center phase angle of valve lifting of intake valves 4, whereas the exhaust side is provided with exhaust-side variable valve mechanism (henceforth referred to as exhaust-side VTC mechanism) 1B as a “phase angle varying mechanism” structured to control a center phase angle of valve lifting of exhaust valves 5. Furthermore, variable compression ratio mechanism (henceforth referred to as VCR mechanism) 3 is provided as a “variable piston stroke mechanism” structured to control the mechanical compression ratio εC and mechanical expansion ratio εE of the cylinder. In this example, VCR mechanism 3 is structured to set the mechanical compression ratio εC and mechanical expansion ratio εE equal to each other.

Each of intake-side VTC mechanism 1A and exhaust-side VTC mechanism 1B includes a phase control hydraulic actuator 2A, 2B, and is structured to hydraulically control the opening and closing timings of intake valves 4 or exhaust valves 5. Hydraulic pressure supply to phase control hydraulic actuator 2A, 2B is controlled by a hydraulic control unit not shown based on control signals from controller 22. By the hydraulic control of phase control hydraulic actuator 2A, 2B, the center phase θ of the lift curve is controlled to be advanced and retarded.

In this way, the lift curve has a constant shape, but is moved as a whole in an advance direction and a retard direction. This movement is carried out continuously. Each of intake-side VTC mechanism 1A and exhaust-side VTC mechanism 1B is not limited to the hydraulic type, but may be variously implemented, for example, by employing an electric motor or an electromagnetic actuator.

Controller 22 identifies a current state of the internal combustion engine, based on an output signal from a crank angle sensor for measuring a current rotation speed Ne [rpm] of the internal combustion engine from crank angle information, and various information signals such as an intake air quantity (i.e. load) from an air flow meter, an accelerator opening sensor, a vehicle speed sensor, a gear position sensor, an engine coolant temperature sensor 31 for sensing a temperature of an engine body, and an atmospheric humidity sensor for sensing humidity in an intake pipe. Controller 22 then outputs at least an intake VTC control signal to intake-side VTC mechanism 1A and an exhaust VTC control signal to exhaust-side VTC mechanism 1B.

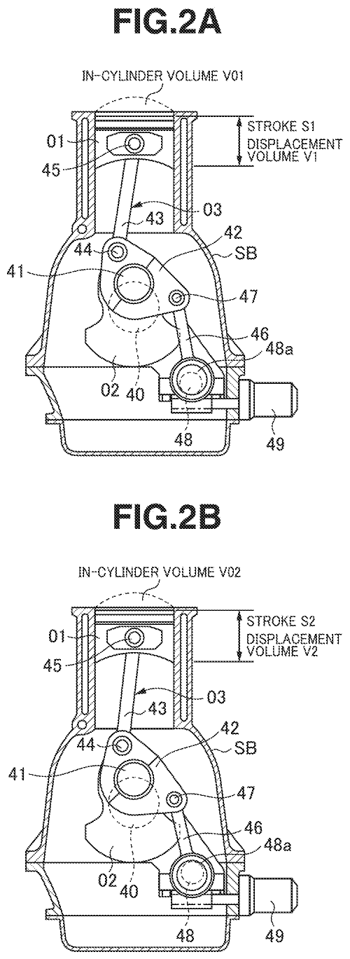

The following describes VCR mechanism 3 with reference to FIGS. 1, 2A and 2B. FIG. 2A shows where the piston is positioned at compression top dead center, when the mechanical compression ratio is set to the minimum mechanical compression ratio point, and the engine is in a high load region after warm-up. FIG. 2B shows where the piston is positioned at compression top dead center, when the mechanical compression ratio is set to the maximum mechanical compression ratio point, and the engine is in a state from cold start to a low to middle load region. The position of the piston at exhaust top dead center is identical to that at compression top dead center shown in FIGS. 2A and 2B, irrespective of whether the mechanical compression ratio is set to the minimum mechanical compression ratio point or the maximum mechanical compression ratio point.

VCR mechanism 3 has a cycle of crank angle of 360°, so that the piston position at compression top dead center is theoretically identical to the piston position at exhaust top dead center. Similarly, the piston position at intake bottom dead center is identical to the piston position at expansion bottom dead center. This means that the compression stroke from the piston position at intake bottom dead center to the piston position at compression top dead center is constantly equal to the expansion stroke from the piston position at compression top dead center to the piston position at expansion bottom dead center, regardless of the position control. Accordingly, the mechanical compression ratio εC and mechanical expansion ratio εE are constantly equal to each other theoretically (εC=εE), regardless of the position control.

VCR mechanism 3 is configured as disclosed in patent document 1 described above as conventional. The following describes its structure briefly. Crankshaft 02 includes journal parts 40 and crank pin parts 41, wherein journal parts 40 are rotatably supported by a main bearing of cylinder block SB. Each crank pin part 41 is eccentric from journal parts 40 by a predetermined distance, wherein lower link 42 as a second link is rotatably connected to crank pin part 41. Lower link 42 is composed of two parts that can be separated laterally, and includes a connection hole substantially at its center where crank pin part 41 is fitted.

Upper link 43 as a first link includes a lower end pivotably connected to a first end of lower link 42 by a connecting pin 44, and an upper end pivotally connected to piston 01 by a piston pin 45. As a third link, a control link 46 includes an upper end pivotally connected to a second end of lower link 42 by a connecting pin 47, and a lower end pivotally connected via a control shaft 48 to a lower part of cylinder block SB that is a part of the engine body.

Control shaft 48 is rotatably supported with respect to the engine body, and includes an eccentric cam part 48a that is eccentric from a rotation center of control shaft 48, wherein a lower end portion of control link 46 is rotatably fitted with eccentric cam part 48a. The rotational position of control shaft 48 is controlled by a compression ratio control actuator 49 employing an electric motor, based on a control signal from controller 22.

In VCR mechanism 3 based on the multi-link piston-crank mechanism as described above, rotation of control shaft 48 caused by compression ratio control actuator 49 causes a change in the center position of eccentric cam part 48a with respect to the engine body. This causes a change in the position where the lower end of control link 46 is pivotally supported. This change causes an upward or downward movement of the position of piston 01 at top dead center, and also causes a change in the stroke of piston 01 as indicated by S1 and S2 in FIGS. 2A and 2B. This makes it possible to change the mechanical compression ratio (εC) and mechanical expansion ratio (εE).

The mechanical compression ratio (εC) is a compression ratio geometrically determined only by a change in volume of the combustion chamber caused by the stroke of piston 01, and is specifically a ratio of the in-cylinder volume at bottom dead center of piston 01 on the intake stroke with respect to the cylinder volume at top dead center of piston 01 on the compression stroke. FIG. 2A shows a state of the minimum mechanical compression ratio point, whereas FIG. 2B shows a state of the maximum mechanical compression ratio point. The mechanical compression ratio can be continuously varied therebetween.

Where VO represents the in-cylinder volume at piston compression top dead center, and V represents the displacement volume, the in-cylinder volume at piston bottom dead center is equal to “VO+V”, so that the mechanical compression ratio (εC) is expressed as “εC=(VO+V)/VO=V/VO+1”. Based on this formula, the minimum mechanical compression ratio point (εC min=minimum mechanical expansion ratio point εE min) shown in FIG. 2A is expressed as “εC min=V1/VO1+1” (for example, εC min=8), and the maximum mechanical compression ratio point (εC max=maximum mechanical expansion ratio point εE max) shown in FIG. 2B is expressed as “εC max=V2/VO2+1” (for example, εC max=18).

As discussed in the section “Problem(s) to be Solved by the Invention”, according to non-patent document 1, at cold start of the internal combustion engine, the mechanical compression ratio (εC) is set to the maximum mechanical compression ratio point, and the mechanical expansion ratio (εE) is also set to the maximum mechanical expansion ratio point. This causes a phenomenon that the temperature of exhaust gas of the internal combustion engine falls. This suppresses an exhaust gas purifying catalyst, which is provided in an exhaust pipe, from being warmed up, and thereby causes a decrease in conversion ratio in the exhaust gas purification catalyst for adverse components of exhaust gas. This causes a problematic increase in quantity of adverse components of exhaust gas that is exhausted through a tail pipe to the atmosphere after passing through the exhaust gas purifying catalyst.

For solving the problem described above, the present embodiment is configured such that at a cold start of the internal combustion engine, the exhaust-side VTC mechanism sets the opening timing of the exhaust valve advanced at or close to a “midpoint angular position” between top dead center and bottom dead center, and sets the closing timing of the exhaust valve advanced at a preset point before top dead center, and the intake-side VTC mechanism sets the opening timing of the intake valve retarded at a preset point after top dead center. The exhaust-side VTC mechanism and the intake-side VTC mechanism are controlled as follows.

First, the intake-side VTC mechanism 1A of the present embodiment is structured to be mechanically controlled to be stably at or close to the “midpoint angular position” as a default position, when hydraulic pressure is supplied from a hydraulic pump, and also when no hydraulic pressure is supplied from the hydraulic pump. The default position is a position where intake-side VTC mechanism 1A is mechanically stable.

Phase control hydraulic actuator 2A employs a bias spring that biases vanes in the advance direction. Its biasing force is small so that the vanes are mechanically pushed back to vicinity of the “midpoint angular position” due a valve operating reaction force. As the engine speed falls with this phase, the hydraulic pressure gradually decreases, and the phase in the vicinity of “midpoint angular position” is pin-locked. Namely, the default position is at or close to the “midpoint angular position” between a “most retarded position” and a “most advanced position”.

This produces a mechanical fail-safe function for a situation of disconnection failure or the like in an electric system. As described below, when the internal combustion engine is at rest, intake valve 4 is set in the vicinity of “midpoint angular position”.

Then, exhaust-side VTC mechanism 1B of the present embodiment is structured to be mechanically controlled to be stably at or close to a “most advanced position” as a default position, when hydraulic pressure is supplied from the hydraulic pump, and also when no hydraulic pressure is supplied from the hydraulic pump.

Phase control hydraulic actuator 2B employs a bias spring that biases vanes in the advance direction. When no hydraulic pressure is applied to the vanes, the vanes are maintained stably in vicinity of the “most advanced position”. As the engine speed falls with this phase, the hydraulic pressure gradually decreases, and the phase in the vicinity of the “most advanced position” is pin-locked. Namely, the “most advanced position” is the default position.

This produces a mechanical fail-safe function for a situation of disconnection failure or the like in an electric system. As described below, when the internal combustion engine is at rest, exhaust valve 5 is set in the vicinity of “most advanced position”.

Further description of intake-side VTC mechanism 1A and exhaust-side VTC mechanism 1B is omitted, because JP 2011-220349 A and JP 2013-170498 A, which were made by the present applicant, disclose in detail basic configurations of intake-side VTC mechanism 1A and exhaust-side VTC mechanism 1B. The present embodiment employs the intake-side VTC mechanism and exhaust-side variable valve mechanism described in JP-2011-220349 A, while setting the default positions as described above.

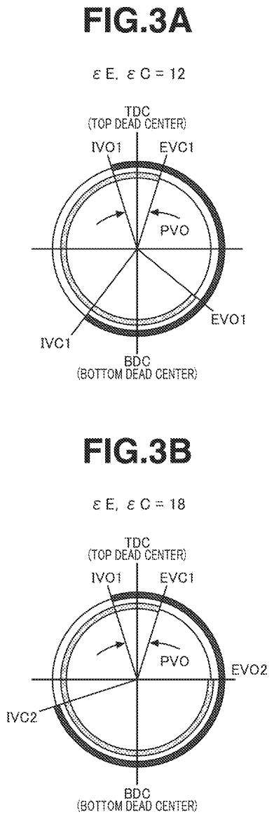

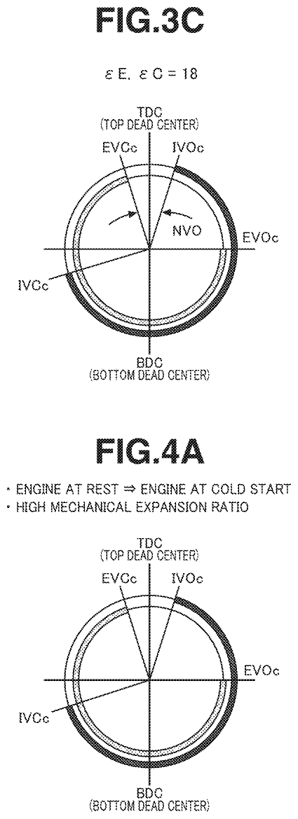

The following describes valve timings of intake valve 4 and exhaust valve 5 during a cold operation including a cold start. FIGS. 3A to 3C are diagrams illustrating valve timings of intake valve 4 and exhaust valve 5 during the cold operation, when phase control hydraulic actuators 2A, 2B are in their default positions.

FIG. 3A shows valve timings with a “positive valve overlap” at a normal mechanical expansion ratio point (εE=12). FIG. 3B shows valve timings with a “positive valve overlap” at a high mechanical expansion ratio point (εE=18). FIG. 3C shows valve timings with a “negative valve overlap” at the high mechanical expansion ratio point (εE=18).

FIG. 3A shows a case of normal mechanical expansion ratio point (εE=12), where the opening timing of intake valve 4 is set to an opening timing point IVO1 before top dead center, and the closing timing of intake valve 4 is set to a closing timing point IVC1 after bottom dead center, and the opening timing of exhaust valve 5 is set to an opening timing point EVO1 before bottom dead center, and the closing timing of exhaust valve 5 is set to a closing timing point EVC1 after top dead center. This setting causes a “positive valve overlap” (henceforth referred to as PVO period) during which hot combustion gas (EGR gas) is supplied to an intake system, and reintroduced into the cylinder during the next intake stroke so as to increase the temperature of the air-fuel mixture, and the closing timing IVC of intake valve 4 is set relatively close to bottom dead center so as to increase the temperature at compression top dead center, thereby improving combustion during cold engine operation, and suppressing the occurrence of adverse components of exhaust gas.

Incidentally, increasing the temperature at compression top dead center by increasing the mechanical compression ratio (=mechanical expansion ratio) during cold operation as described above, serves to improve combustion during cold operation, and thereby achieve preferable start and operation. Therefore, for an internal combustion engine that is set to a high mechanical expansion ratio, and set to the valve timings shown FIG. 3A, it is conceivable to change the valve timings as shown in FIG. 3B. In this case, the opening timing of intake valve 4 is set to the opening timing point IVO1 and the closing timing of exhaust valve 5 is set to the closing timing point EVC1 as in the case of FIG. 3A, providing the same PVO period. However, the high mechanical expansion ratio may cause a decrease in the combustion gas temperature at the opening timing of the exhaust valve, namely, a decrease in the exhaust temperature, and thereby reduce the catalytic conversion ratio. From this viewpoint, the opening timing of exhaust valve 5 is set advanced from the opening timing point EVO1 to an opening timing point EVO2, so that exhaust valve 5 is opened while the combustion gas temperature is high. This serves to set the combustion gas temperature as in the case of the normal mechanical expansion ratio shown in FIG. 3A, and thereby maintain the catalytic conversion performance unchanged.

There is a possibility that the increased mechanical compression ratio causes an increase in compression, and thereby causes an increase in load applied to a starter motor. However, the setting of retarding the closing timing of intake valve 4 from the closing timing point IVC1 to a closing timing point IVC2 away from bottom dead center serves to maintain the degree of compression as for the normal mechanical compression ratio.

However, since the PVO period is maintained unchanged substantially, the operating angles (valve opening periods) of exhaust valve 5 and intake valve 4 are expanded depending on the setting. This may increase mechanical friction of a valve operating system, and thereby adversely affect the fuel efficiency and increase the adverse components of exhaust gas.

In order to solve the problems described above, as shown in FIG. 3C, the present embodiment is configured to advance the opening timing of exhaust valve 5 to an opening timing point EVOc (=EVO2), and open the exhaust valve 5 while the combustion gas temperature is high, and retard the closing timing of intake valve 4 to a closing timing point IVCc (=IVC2) away from bottom dead center, and further retard the opening timing of intake valve 4 to an opening timing point IVOc (first preset retard-side point) after top dead center, and advance the closing timing of exhaust valve 5 to a closing timing point EVCc (first preset advance-side point) before top dead center.

The opening timing point EVOc of exhaust valve 5 is set at or close to a midpoint between top dead center and bottom dead center. Preferably, the opening timing point EVOc is set in a range of 90°±20°˜30° or so in the advance direction (counterclockwise direction) from expansion bottom dead center as shown in FIG. 3C.

The advanced EVCc and the retarded IVOc described above cause a “negative valve overlap” between exhaust valve set 5 and intake valve 4 (henceforth referred to as NVO period). This serves to reduce the operating angles (valve opening periods) of exhaust valve set 5 and intake valve 4, and thereby suppress the mechanical friction of the valve operating system from being increased. Furthermore, the employment of the valve timings shown in FIG. 3C serves to produce actions and effects as follows.

<1> Even during cold operation at high mechanical expansion ratio, by sufficiently advancing the opening timing EVO of exhaust valve 5, it is possible to increase the combustion gas temperature at the opening timing of the exhaust valve, i.e. increase the exhaust temperature, and thereby early warm-up and enhance the conversion ratio of the exhaust gas purification catalyst. Namely, it is possible not only to exhaust hot combustion gas (exhaust gas) by opening the exhaust valve 5 while the combustion temperature is high after combustion, but also to exhaust hot combustion gas swiftly under high pressure by opening the exhaust valve 5 while the in-cylinder pressure is high. This serves to further enhance the activity of the catalyst, and effectively reduce the adverse components of exhaust gas during cold operation.

<2> Furthermore, by enclosing and pressing by the piston the hot combustion gas in the cylinder during the NVO period defined by the closing timing point EVCc of exhaust valve 5 and the opening timing point IVOc of intake valve 4, it is possible to heat the in-cylinder gas and the engine body, and thereby significantly improve combustion during cold operation, and reduce the fuel consumption and adverse components of exhaust gas, and increase the engine warm-up performance (the rate of increase of the engine temperature), and thereby further enhance the warm-up rate of the catalyst. This is accompanied by a rise in oil temperature, which serves to reduce the mechanical friction of the internal combustion engine correspondingly, thereby also reducing fuel consumption when the internal combustion engine is in cold state.

<3> In addition, although the closing timing point IVCc of intake valve 4 is identical to the closing timing IVC2 shown in FIG. 3B, the formation of the NVO period causes the opening timing point IVOc of intake valve 4 to be retarded relative to the point of FIG. 3B, and reduces the operating angle of intake valve 4. Similarly, although the opening timing point EVOc of exhaust valve 5 is identical to the opening timing EVO2 shown in FIG. 3B, the early closing timing point EVCc of the exhaust valve 5 with respect to FIG. 3B, serves to reduce the operating angle of exhaust valve 5, and thereby reduce the mechanical friction of the valve system correspondingly, and also reduce fuel consumption.

In this way, according to the valve timing of the present embodiment shown in FIG. 3C, it is possible to improve combustion by the formation of NVO period, and also reduce the mechanical friction of the valve operating system, and thereby reduce the fuel consumption and adverse components of exhaust gas. Furthermore, the feature of advancing the opening timing of exhaust valve 5 to the opening timing point EVOc that is the midpoint between top dead center and bottom dead center, serves to suppress the exhaust gas temperature from falling due to the high mechanical expansion ratio, and thereby increase the exhaust gas temperature.

The further feature that the exhaust gas can be exhausted under high pressure, serves to promote the warm-up and activation of the exhaust gas purifying catalyst, and further enhance the conversion ratio of the catalyst, and thereby reduce the adverse components of exhaust gas that is finally exhausted to the atmosphere. Moreover, the feature that the valve timing shown in FIG. 3C is set at and after an initial stage of cranking, serves to produce the effect of reducing the adverse components of exhaust gas described above at and after an initial stage of starting combustion. Furthermore, the feature that the phase center of NVO is at or close to top dead center (TDC), i.e., the period between EVCc and TDC and the period between TDC and IVOc are substantially equal to each other, serves to produce a special effect. Specifically, the in-cylinder pressure at the exhaust valve closing timing point EVCc is at or close to the atmospheric pressure, and then in-cylinder pressurization begins, so that the pressure rises toward TDC, and thereafter returns at or close to the atmospheric pressure, and then the intake valve is opened. This suppresses the occurrence of pumping loss during the period between EVCc and IVOc. This serves to suppress the fuel consumption from being adversely affected by the pumping loss. If IVOc is relatively early, i.e. the intake valve is opened early, pressurized combustion gas (EGR gas) is exhausted into the intake system, not only to increase the pump loss, but also to cool the warmed combustion gas in the intake system, so that the combustion is adversely affected by the temperature drop when the gas is introduced into the cylinder on the next cycle. In this way, the feature that the phase center of NVO is at or close to top dead center (TDC), i.e., the period between EVCc and TDC and the period between TDC and IVOc are substantially equal to each other, serves to produce a special effect.

Although combustion gas can be introduced into the cylinder also with the PVO period, this case includes a process where the combustion gas is swept into the intake system, and thereafter introduced again into the cylinder during the subsequent intake stroke, so that the combustion gas the temperature is theoretically lower than the gas temperature during the NVO period according to the present embodiment. Furthermore, this setting requires the opening periods (working angles) of intake valve 4 and exhaust valve 5 to be also set large, and thereby causes an adverse effect due to the increase in mechanical friction of the valve operating system, and fails to produce the action and effect according to this embodiment described above.

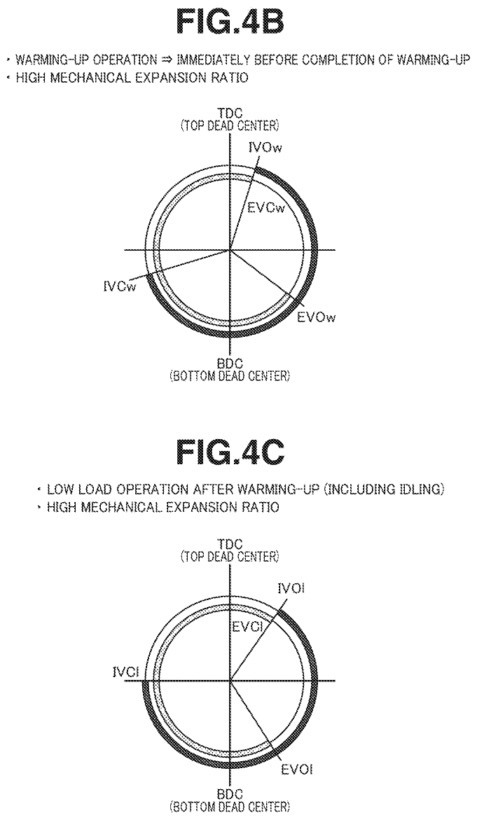

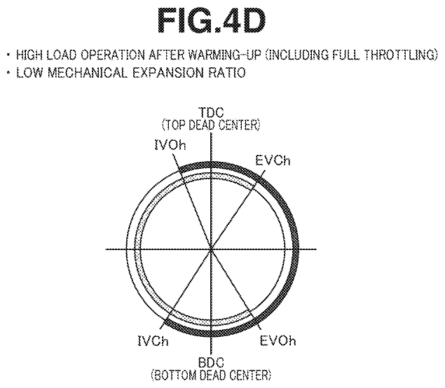

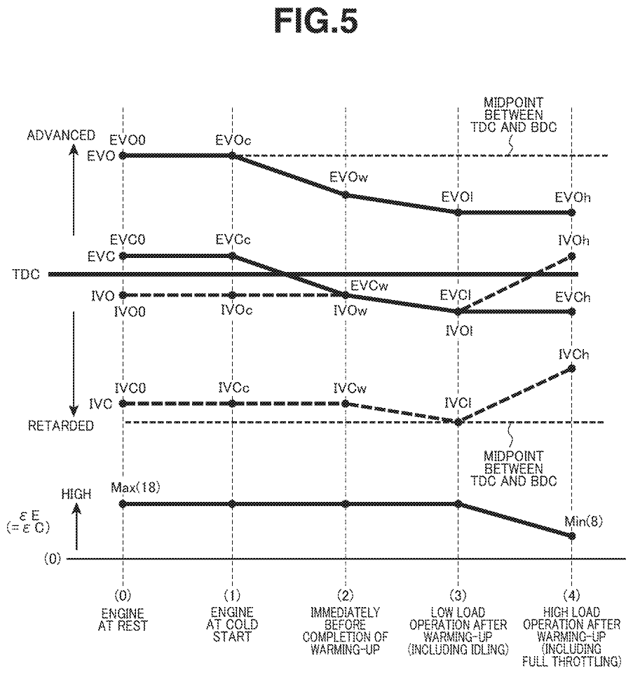

The following describes a control operation of the valve timing and mechanical expansion ratio (mechanical compression ratio) corresponding to changes in operating state with reference to FIGS. 4A to 4D and 5. FIG. 4A shows valve timings during a period from a condition that the engine is at rest to a condition that the engine is at cold start, with the mechanical expansion ratio set to a high mechanical expansion ratio point. FIG. 4B shows valve timings immediately before warming-up of the internal combustion engine is completed after the warming-up is started, with the mechanical expansion ratio set to the high mechanical expansion ratio point. FIG. 4C shows valve timings when the internal combustion engine is in a low load region after the warming-up, with the mechanical expansion ratio set to the high mechanical expansion ratio point. FIG. 4D shows valve timings when the internal combustion engine is in a high load region after the warming-up, with the mechanical expansion ratio set to a low mechanical expansion ratio point (low mechanical compression ratio point). FIG. 5 shows how the opening timing EVO and closing timing EVC of exhaust valve 5 (indicated by solid lines), the opening timing IVO and closing timing IVC of intake valve 4 (indicated by broken lines), and the mechanical expansion ratio (=mechanical compression ratio) change with time.

<From Engine Stop to Engine Start> As shown in FIG. 4A and FIG. 5 (0), (1), the opening timing of exhaust valve 5 is advanced at the opening timing point EVOc to open the exhaust valve 5 while the combustion gas temperature is high, and the closing timing of intake valve 4 is retarded at the closing timing point IVCc away from bottom dead center, and the opening timing of intake valve 4 is retarded at the opening timing point IVOc after top dead center TDC (first preset retard-side point), and the closing timing of exhaust valve 5 is advanced at the closing timing point EVCc before top dead center (first preset advance-side point). The opening timing point EVOc of exhaust valve 5 is set in a range of 90°±20°˜30° in the advance direction (counterclockwise direction) from expansion bottom dead center as shown in FIG. 3C. This state is identical to the state of FIG. 3C, and description thereof is omitted (effects are produced as described above).

In the present embodiment, during cold start, the mechanical expansion ratio is controlled to a high mechanical expansion ratio point (for example, maximum mechanical expansion ratio point εE max) greater than the minimum mechanical expansion ratio point (εE min) by VCR mechanism 3. Since the exhaust gas temperature decreases to be lower because of high thermal efficiency, there is a possibility that the adverse components of exhaust gas when the internal combustion engine is in cold state are increased by a relative decrease in the catalyst conversion ratio. Even in such a situation, the setting of the opening timing of exhaust valve set 5 (EVO) at the advanced opening timing point (EVOc), serves to suppress the exhaust gas temperature from dropping, and maintaining the catalyst conversion ratio high, and enhance the effect of reducing the adverse components of exhaust gas.

<Immediately Before Completion of Warm-Up Operation After Start of Warm-Up> As shown in FIG. 4B and FIG. 5 (2), as the temperature of the internal combustion engine rises while the internal combustion engine is cold-started and warmed up, the opening timing EVO of exhaust valve 5 is caused to shift gradually in the retard direction as shown in in FIG. 5. The catalyst temperature (catalyst conversion ratio) gradually increases as the temperature of the internal combustion engine increases. Therefore, the opening timing of exhaust valve 5 is shifted to an opening timing point EVOw in the retard direction, to suppress excessive increase in the catalyst temperature, and also improve the fuel consumption since the retard of EVO sets a high effective expansion ratio (increase in expansion work).

In addition, since the opening timing EVO of exhaust valve 5 gradually shifts in the retard direction, the closing timing EVC of exhaust valve set 5 also shifts to a closing timing point EVCw in the retard direction as the temperature of the internal combustion engine rises. This causes a decrease in quantity of hot EGR gas enclosed in the cylinder, and suppresses an excessive temperature rise more than required for the internal combustion engine and the catalyst, and causes a decrease in the quantity of exhaust gas in the cylinder (EGR gas quantity), and thereby improves the combustion stability during transient operation, and produces a preferable acceleration response to a rapid acceleration request or the like.

When the internal combustion engine reaches a predetermined temperature T0, the warm-up operation is completed. Immediately before the completion, the valve timing is set as shown in FIG. 4B, so that the closing timing of exhaust valve 5 is retarded to the closing timing point EVCw substantially equal to the opening timing point IVOw of intake valve 4, so that the valve overlap is substantially equal to zero, and the internal EGR quantity is significantly reduced.

<Low Load After Warm-Up> As shown in FIG. 4C and FIG. 5 (3), at the time of low load after completion of warming-up, a control is performed such that the opening and closing timings of exhaust valve 5 are retarded to an opening timing point EVOl and a closing timing point EVCl (second preset retard-side point), and the opening and closing timings of intake valve 4 are retarded to an opening timing point IVOl and a closing timing point IVCl. This sets the NVO period substantially equal to zero, or provides a PVO period, and the closing timing point IVCl of intake valve 4 is set retarded at or close to a midpoint between top dead center and bottom dead center. The closing timing point IVCl is set in a range of 90°±20°˜30° in the retard direction (clockwise direction) from intake bottom dead center.

This setting serves to increase the expansion work by retarding the opening timing of exhaust valve 5 to the opening timing point EVOl, and reduce the pumping loss by a so-called intake valve delayed closing Atkinson cycle effect by retarding the closing timing of intake valve 4 to the closing time point IVCl, and further reduce a pumping loss in an initial stage of the intake stroke that can occur in the vicinity of TDC, by no formation of NVO period, and thereby reduce the total pumping loss, and improve the fuel efficiency.

<High Load After Warm-Up> As shown in FIG. 4D and FIG. 5 (4), at the time of high load after completion of the warming-up, a control is performed such that the opening and closing timings of exhaust valve 5 are retarded to an opening timing point EVOh and a closing timing point EVCh (third preset retard-side point), and the opening and closing timings of intake valve 4 are advanced to an opening timing point IVOh (second present advance-side point) and a closing timing point IVCh. This causes a large PVO period and advances the closing timing of intake valve 4 to the closing timing point IVCh toward bottom dead center.

This setting serves to improve the charging efficiency by advancing the closing timing of intake valve 4 to the closing timing point IVCh toward bottom dead center, and further enhance a so-called scavenging function (i.e. a method of directing fresh air into the cylinder by synchronization between a negative pressure wave of exhaust pulsation and the PVO period by delaying the occurrence of the negative pressure wave) by forming the large PVO period and retarding the opening timing of exhaust valve 5 to the opening timing point EVOh, and thereby sufficiently enhance the engine torque. Furthermore, since the mechanical compression ratio is controlled to the minimum mechanical compression ratio point εC min (=about 8), it is possible to improve knock resistance and further enhance the engine torque.

In the present embodiment, the employment of VCR mechanism 3 produces actions and effects as follows. For example, by controlling the mechanical expansion ratio to a high mechanical expansion ratio point by the VCR mechanism in a low speed and low load region, it is possible to further enhance the effect of improving the fuel efficiency in the low speed and low load region. Furthermore, by controlling the mechanical compression ratio to a low mechanical compression ratio by the VCR mechanism in a low speed and high load region, it is possible to prevent knocking and further improve the engine torque in the low speed and high load region.

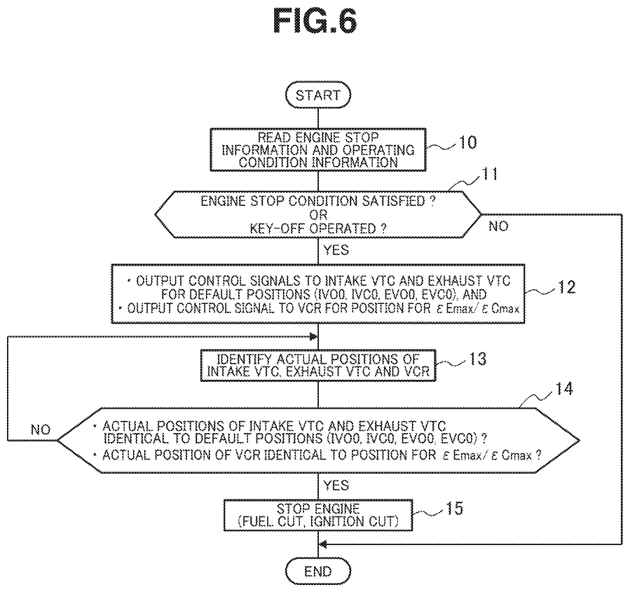

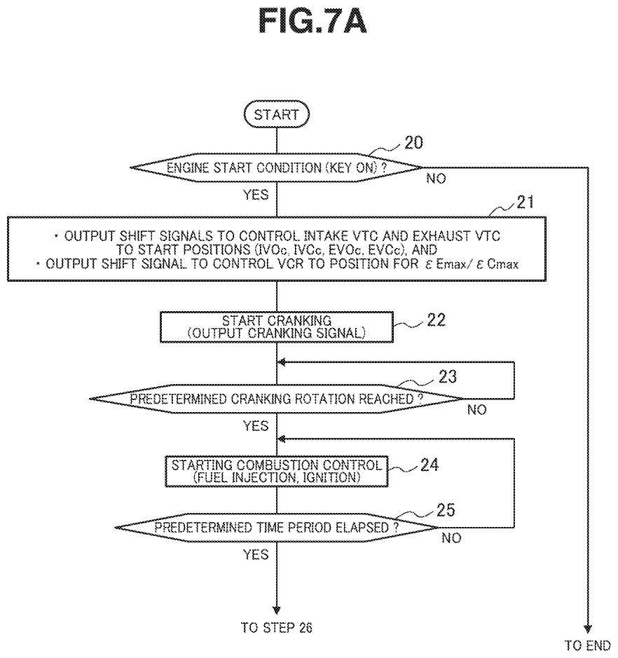

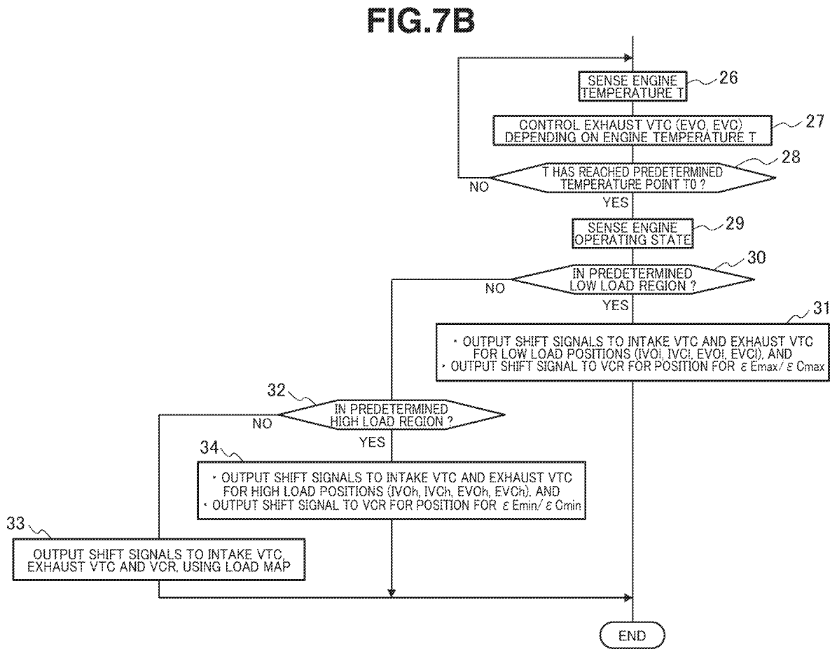

The following briefly describes a control flow for performing a control about the valve timings shown in FIGS. 4A to 4D described above, with reference to FIGS. 6, 7A and 7B. This control flow is activated at intervals of 10 [ms] in this example, and performed by a microcomputer installed in controller 22.

FIG. 6 shows a control flow for causing the intake-side VTC mechanism 1A, exhaust-side VTC mechanism 1B, and VCR mechanism 3 to be mechanically moved to their default positions during a stopping phase for stopping the internal combustion engine.

<Step S10> First, at Step S10, it reads engine stop information for stopping the internal combustion engine, and operation condition information about the internal combustion engine. The engine stop information for stopping the internal combustion engine is typically a condition that idling stop requirements are satisfied, or may be a key-off signal depending on driver's intention. There are many signals indicating the operating condition information about the internal combustion engine. In the present embodiment, the signals include rotational speed information, intake air quantity information, water temperature information, requested load information (accelerator opening), and others as to the internal combustion engine, and actual position information regarding the intake-side VTC mechanism 1A and exhaust-side VTC mechanism 1B. After reading the various pieces of information at Step S10, the process proceeds to Step S11.

<Step S11> At Step S11, it determines whether or not an engine stop transition condition is satisfied, or whether or not key-off operation occurs. Determination whether or not key-off operation occurs may be implemented, for example, by monitoring a key-off signal. When the key-off signal is not inputted, the process then proceeds to an end, and awaits a next activation timing. On the other hand, when the key-off signal is inputted, or when the engine stop transition condition is satisfied, the process then proceeds to Step S12.

<Step S12> At Step S12, it outputs shift control signals to phase control hydraulic actuator 2A of intake-side VTC mechanism 1A, phase control hydraulic actuator 2B of exhaust-side VTC mechanism 1B, and compression ratio control actuator 49 of VCR mechanism 3, so as to cause intake-side VTC mechanism 1A, exhaust-side VTC mechanism 1B, and VCR mechanism 3 to shift to their default positions. Namely, in order to prepare for a next start-up, a control is performed to achieve valve opening and closing timing characteristics and piston position characteristics shown as “engine at rest->engine at cold start” in FIG. 4A and in FIG. 5 (0). Specifically, the system is structured to be mechanically returned to the default positions by blocking the shift control signals. Accordingly, this control may be performed by blocking the shift control signals.

In this way, as shown in FIG. 5 (0), the opening timing (IVO) of intake valve 4 is set in vicinity of an opening timing point IVOo, and the closing timing (IVC) of intake valve 4 is set in vicinity of a closing timing point IVCo, and the opening timing (EVO) of exhaust valve 5 is set in vicinity of an opening timing point EVOo, and the closing timing (EVC) of exhaust valve 5 is set in vicinity of a closing timing point EVCo.

Furthermore, the mechanical expansion ratio (εE) set by VCR mechanism 3 is set to a high mechanical expansion ratio point (=high mechanical compression ratio point), and in this example, is set to the maximum mechanical expansion ratio point (εE max). When the output of setting of intake-side VTC mechanism 1A, exhaust-side VTC mechanism 1B, and VCR mechanism 3 to the default positions is completed, the process then proceeds to Step S13.

<Step S13> At Step S13, it monitors a state of control by determining an actual position of each of phase control hydraulic actuator 2A of intake-side VTC mechanism 1A, phase control hydraulic actuator 2B of exhaust-side VTC mechanism 1B, and compression ratio control actuator 49 of VCR mechanism 3. When the determination of each actual position is completed, the process then proceeds to Step S14.

<Step S14> At Step S14, it determines based on each actual position whether or not intake valve 4 is set in the vicinity of the opening timing point IVOo and in the vicinity of the closing timing point IVCo, and exhaust valve 5 is set in the vicinity of the opening timing point EVOo and in the vicinity of the closing timing point EVCo, and the mechanical expansion ratio (εE) is set to the maximum mechanical expansion ratio point εE max. When this condition is not satisfied, the process then returns to Step S13 where the same control is executed.

On the other hand, when it is determined based on each actual position that intake valve 4 is set in the vicinity of the opening timing point IVOo and in the vicinity of the closing timing point IVCo, and exhaust valve 5 is set in the vicinity of the opening timing point EVOo and in the vicinity of the closing timing point EVCo, and the mechanical expansion ratio (εE) is set to the maximum mechanical expansion ratio point εE max, the process then proceeds to Step S15.

<Step S15> At Step S15, it sends a fuel cut signal to the fuel injection valve so as to stop the internal combustion engine, and also sends an ignition cut signal to the ignition device. This causes a decrease in rotation speed Ne of the internal combustion engine, and thereby stops the internal combustion engine. In this way, the setting of intake-side VTC mechanism 1A, exhaust-side VTC mechanism 1B, and VCR mechanism 3 to the default positions is completed actually, and the internal combustion engine starts to stop, and the process proceeds to the end, and awaits a next start-up of the internal combustion.

The following describes a control flow for restarting operation of the internal combustion engine from this state with reference to FIGS. 7A and 7B. This control flow is executed by the microcomputer installed in the controller 22.

<Step S20> At Step S20, it determines whether or not an engine starting condition is satisfied. This determination may be implemented, for example, by monitoring a key-on signal or a starter activation signal. When the key-on start signal is not inputted, the process then proceeds to the end, and waits for a next activation timing. On the other hand, when the key-on start signal is inputted, it determines that the engine starting condition is satisfied, and the process then proceeds to Step S21.

<Step S21> At Step S21, it outputs shift control signals to phase control hydraulic actuator 2A of intake-side VTC mechanism 1A and phase control hydraulic actuator 2B of exhaust-side VTC mechanism 1B so as to shift the intake-side VTC mechanism 1A and exhaust-side VTC mechanism 1B to their start positions (which are the default positions in this example). It further outputs a shift control signal to compression ratio control actuator 49 of VCR mechanism 3. Namely, in order to prepare for start-up, a control is performed to achieve characteristics of the valve opening and closing timings and piston position as shown as “engine at cold start” in FIG. 4A.

Thus, as shown in FIG. 5, the opening timing (IVO) of intake valve 4 is set to the opening timing point IVOc, and the closing timing (IVC) of intake valve 4 is set to the closing timing point IVCc, and the closing timing (EVC) of exhaust valve 5 is set to the closing timing point EVCc. Furthermore, the mechanical expansion ratio (εE) is set to the maximum mechanical expansion ratio point εE max.

Under this condition, the opening and closing timings of exhaust valve 5 and intake valve 4 at cold start are set to the default opening and closing timing points as for the stop condition, and the mechanical expansion ratio is set to maximum mechanical expansion ratio point (εE max) as for the stop condition. This serves to achieve a smooth start without requiring a substantive shift operation. In addition, this produces a mechanical fail-safe effect.

After outputting the shift control signals to phase control hydraulic actuator 2A of intake-side VTC mechanism 1A, phase control hydraulic actuator 2B of exhaust-side variable valve mechanism 1B, and compression ratio control actuator 49 of VCR mechanism 3, the process proceeds to Steps S22 and S23.

<Step S22, Step S23> At Step S22, it starts cranking by the starter motor, and subsequently at Step S23, it determines whether or not the rotational speed Ne has reached a predetermined cranking speed. When the rotation speed Ne has not reached the predetermined cranking rotational speed, it then repeats this determination. Then, when the rotation speed Ne reaches the predetermined cranking rotation, the process then proceeds to Step S24.

<Step S24> At Step S24, it supplies driving signals to the fuel injection valve and the ignition device for starting the internal combustion engine in accordance with rotation of the starter motor. After supplying the driving signals to the fuel injection valve and ignition device, the process proceeds to Step S25.

<Step S25> At Step S25, it determines whether or not a predetermined time has elapsed since the cranking. When the predetermined time has not elapsed, it then repeats this determination. When the predetermined time has elapsed, the process then proceeds to Step 26 and Step 27.

<Step S26, Step S27> At Step S26, it senses the engine temperature T (coolant temperature) of the internal combustion engine, and subsequently at Step S27, it performs based on the engine temperature a control by exhaust-side VTC mechanism 1B to retard the opening timing (EVO) of exhaust valve 5 from the opening timing point EVOc to the opening timing point EVOw, and also retard the closing timing (EVC) of exhaust valve 5 from the closing timing point EVCc to the closing timing point EVCw, as shown in FIG. 5. By retarding the opening and closing timings of exhaust valve 5 in response to increase in the engine temperature, this control serves to increase the actual expansion ratio (effective expansion ratio) as high as possible, and improve the thermal efficiency, and also suppress an unnecessary increase in the engine temperature and exhaust gas temperature by narrowing the NVO period as small as possible, and thereby suppress the fuel consumption.

In this state, the opening timing (IVO) and closing timing (IVC) of intake valve 4 are maintained at the same points as at the time of engine stop, namely, as IVOc=IVOw and IVCc=IVCw. The closing timing of exhaust valve 5 changes to the closing timing point EVCw substantially identical to the opening timing of intake valve 4 set to the opening timing point IVOw, wherein the NVO period is substantially eliminated to significantly reduce the internal EGR quantity. Then, while the retard control of exhaust-side VTC mechanism 1B is being performed, it performs the following steps.

<Step S28> At Step S28, it determines whether or not the sensed engine temperature (coolant temperature) of the internal combustion engine has reached a predetermined temperature To. When the sensed engine temperature (coolant temperature) of the internal combustion engine has not reached the predetermined temperature To, it determines that the engine is in cold state, and executes Steps S26 and S27 again. Until the sensed engine temperature (coolant temperature) of the internal combustion engine reaches the predetermined temperature To, it continues the control process of Steps S26 and S27. Immediately before completion of the warm-up, exhaust valve 5 is set to the opening timing point EVOw and the closing timing point EVCw, and intake valve 4 is set to the opening timing point IVOw and the closing timing point IVCw. Then, when the warm-up of the internal combustion engine proceeds, and the predetermined temperature To is reached, it then determines that the warm-up from cold state is completed, and proceeds to Step S29.

<Step S29> At Step S29, it senses the engine operation state (especially, load state), and then perform a control step described below for controlling the opening timing (EVO) and closing timing (EVC) of exhaust valve 5, and the opening timing (IVO) and closing timing (IVC) of intake valve 4, and the mechanical expansion ratio (εE). The load state is identified by using a load map that has a horizontal axis representing the rotational speed and a vertical axis representing the intake air quantity, for example. After sensing the load state, the process proceeds to Step S30.

<Step S30> At Step S30, it determines whether or not the current engine operating state is in a low load region. When determining that the current engine operating state is in the low load region, it then proceeds to Step S31. When determining that the current engine operating state is in a region of higher load than the low-load state, the process then proceeds to Step S32.

<Step S31> At Step S31, it outputs shift control signals for the low load region to phase control hydraulic actuator 2A of intake-side VTC mechanism 1A, and phase control hydraulic actuator 2B of exhaust-side variable valve mechanism 1B. It also outputs a shift control signal to compression ratio control actuator 49 of VCR mechanism 3. FIG. 5 (3) shows an example of idling state after warm-up.

Accordingly, the opening timing (IVO) of intake valve 4 is set to the opening timing point IVOl, and the closing timing (IVC) of intake valve 4 is set to the closing timing point IVCl, and the closing timing (EVC) of exhaust valve 5 is set to the closing timing point EVCl. Furthermore, the mechanical expansion ratio (εE) is set to the high mechanical expansion ratio (εE max).

The closing timing point EVCl of exhaust valve 5 and the opening timing point IVOl of intake valve 4 are substantially equal to each other, so that the internal EGR quantity is significantly reduced. Then, it outputs shift control signals to phase control hydraulic actuator 2A of intake-side VTC mechanism 1A, and phase control hydraulic actuator 2B of exhaust-side VTC mechanism 1B, and compression ratio control actuator 49 of VCR mechanism 3, and proceeds to the end and waits for a next activation timing.

<Step S32> When the load of the internal combustion engine is determined at Step S30 as being above the low load region after the warm-up, it then executes Step S32. At Step S32, it determines whether or not the current engine operating state is in a high load region. When determining that the current engine operating state is in a region of lower load than the high load region (so-called load map region), it then proceeds to Step S33. When the current engine operating state is in the high load region, the process then proceeds to Step S34.

<Step S33> When determining at Step S32 that the load of the internal combustion engine has not reached the predetermined high-load region after the warm-up, it then executes Step S33. At Step S33, it outputs shift control signals based on the load map to phase control hydraulic actuator 2A of intake-side VTC mechanism 1A, and phase control hydraulic actuator 2B of exhaust-side VTC mechanism 1B. It also outputs a shift control signal to compression ratio control actuator 49 of VCR mechanism 3.

For example, it performs a control by intake-side VTC mechanism 1A to advance the opening timing (IVO) of intake valve 4 from the opening timing point IVOl to the opening timing point IVOh, and the closing timing (IVC) of intake valve 4 from the closing timing point IVCl to the closing timing point IVCh. Under this condition, changes of the opening timing (EVO) and closing timing (EVC) of exhaust valve 5 are suppressed as “EVOl≈EVOh” and “EVCl≈EVCh”, although the opening and closing timings change within a range of EVOl to EVOh and a range of EVCl to EVCh, respectively.

The mechanical expansion ratio (εE) is controlled by compression ratio control actuator 49 of VCR mechanism 3 to decrease from the high mechanical expansion ratio point (εE max) to the low mechanical expansion ratio point (εE min). This sets the mechanical compression ratio to the low mechanical compression ratio point (εC min), and thereby prevents knocking.

Then, it outputs shift control signals to phase control hydraulic actuator 2A of intake-side VTC mechanism 1A, and phase control hydraulic actuator 2B of exhaust-side VTC mechanism 1B, and compression ratio control actuator 49 of VCR mechanism 3, and proceeds to the end and waits for a next activation timing.

<Step S34> When determining at Step S32 that the load of the internal combustion engine has reached the predetermined high load region after the warm-up, it then executes Step S34. At Step S34, it outputs shift control signals for the high load region to phase control hydraulic actuator 2A of intake-side VTC mechanism 1A, and phase control hydraulic actuator 2B of exhaust-side variable valve mechanism 1B. It also outputs a shift control signal to compression ratio control actuator 49 of VCR mechanism 3.

In the high load after warming-up, the opening timing (IVO) of intake valve 4 is set to the opening timing point IVOh, and the closing timing (IVC) of intake valve 4 is set to the closing timing point IVCh, and the opening timing (EVO) of exhaust valve 5 is set to the closing timing point EVOh, and the closing timing (EVC) of exhaust valve 5 is set to the closing timing point EVCh. Furthermore, the mechanical expansion ratio (εE) is set to the low mechanical expansion ratio (εE min).

Then, it outputs shift control signals to phase control hydraulic actuator 2A of intake-side VTC mechanism 1A, and phase control hydraulic actuator 2B of exhaust-side VTC mechanism 1B, and compression ratio control actuator 49 of VCR mechanism 3, and proceeds to the end and waits for a next activation timing.

In the present embodiment, a configuration is proposed which includes: an intake-side VTC mechanism structured to control a phase of opening and closing timings of an intake valve of an internal combustion engine; and an exhaust-side VTC mechanism structured to control a phase of opening and closing timings of an exhaust valve of the internal combustion engine; wherein at a cold start of the internal combustion engine, the exhaust-side VTC mechanism sets the opening timing of the exhaust valve advanced at or close to a midpoint between top dead center and bottom dead center, and sets the closing timing of the exhaust valve advanced at a preset point before top dead center; and the intake-side VTC mechanism sets the opening timing of the intake valve retarded at a preset point after top dead center.

Even when the mechanical expansion ratio is set to the high mechanical expansion ratio point, this configuration serves to enhance the temperature of exhaust gas exhausted from the combustion chamber by sufficiently advancing the opening timing of the exhaust valve at engine start, and thereby early warm up and increase the conversion ratio of the exhaust gas purifying catalyst on the downstream side, as specifically described above.

### Second Embodiment

The following describes a second embodiment of the present invention. In the first embodiment, each of the intake-side VTC mechanism and the exhaust-side VTC mechanism employs a valve operating mechanism where the operating angle (valve opening period) is constant. In contrast, the second embodiment is provided with a variable operating angle mechanism (henceforth referred to as VEL) capable of adjusting the operating angle, in addition to the intake-side VTC mechanism and the exhaust-side VTC mechanism. This serves to produce actions and effects exceeding those of the first embodiment. Specifically, the intake-side variable valve mechanism of the second embodiment includes the intake-side VTC mechanism of the first embodiment and an intake-side VEL, and the exhaust variable valve mechanism of the second embodiment includes the exhaust-side VTC mechanism of the first embodiment and an exhaust-side VEL. The intake-side and exhaust-side VELs are as described in JP 2016-003649 A. Therefore, description of the principle of variation of the operating angle is omitted. This system is also applicable to variable operating angle mechanisms other than VEL.

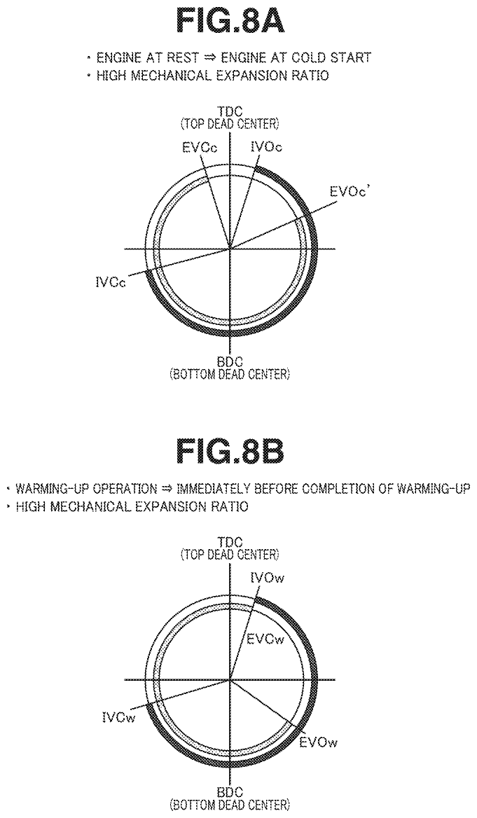

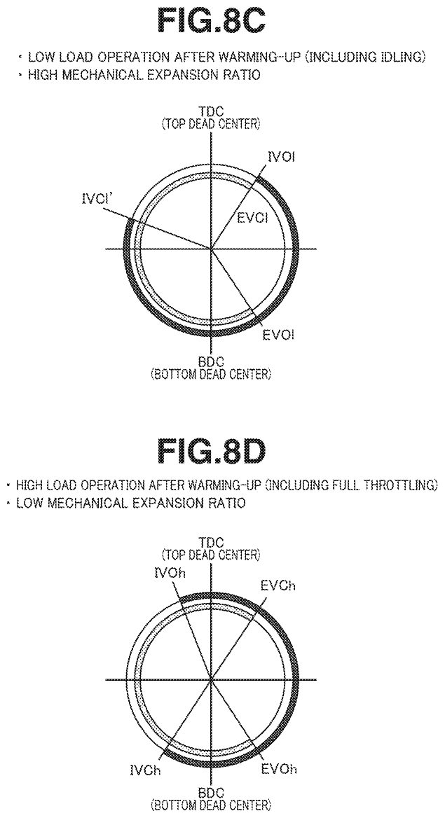

FIGS. 8A to 8D correspond to FIGS. 4A to 4D, wherein FIGS. 8A and 8C show an example that the operating angle of exhaust valve 5 or intake valve 4 is expanded.

In FIG. 8A, the operating angle of exhaust valve 5 is expanded by the exhaust-side VEL mechanism so that the opening timing (EVO) of the exhaust valve 5 is set at an opening timing point EVOc′ advanced from the opening timing point EVOc of the first embodiment. This serves to further increase the combustion temperature of exhaust gas, and warm up more quickly the exhaust gas purifying catalyst, and thereby reduce the adverse components of exhaust gas.

In FIG. 8C, the operating angle of the intake valve 4 is expanded by the intake side VEL mechanism so that the closing timing (IVC) of the intake valve 4 is set to a closing timing point IVCl′ retarded from the opening timing point (IVCl) of the first embodiment. This serves to further reduce the pumping loss by the Atkinson effect, and thereby reduce the fuel consumption.

As can be understood from the above description, the intake-side VTC mechanism and exhaust-side VTC mechanism of the present invention may be a hydraulic variable phase type or an electric variable phase type, or may be provided with a mechanism structured to control the lift. The VCR mechanism is of the type controlling the mechanical compression ratio and the mechanical expansion ratio to a common value, but may be modified as being of a type capable of controlling the mechanical compression ratio and mechanical expansion ratio differently as disclosed in JP 2016-017489 A. As appropriate, the VCR mechanism may be omitted. With the type capable of controlling the mechanical compression ratio and mechanical expansion ratio differently, in the high load after the warm-up corresponding to FIG. 5 (4), the mechanical compression ratio is set to the low mechanical compression ratio point εC min as in the first embodiment to enhance the knock resistance, and the mechanical expansion ratio εE is set higher than εC min. This serves to prevent a problem of catalyst heat deterioration due to high exhaust temperature which occurs at high load, and also produce a special effect such as preventing the emission from being adversely affected with time.

As described above, the present invention is characterized by including: an intake-side variable valve mechanism structured to control a phase of opening and closing timings of an intake valve of an internal combustion engine; and an exhaust-side variable valve mechanism structured to control a phase of opening and closing timings of an exhaust valve of the internal combustion engine; wherein at a cold start of the internal combustion engine, the exhaust-side variable valve mechanism sets the opening timing of the exhaust valve advanced at or close to a midpoint between top dead center and bottom dead center, and sets the closing timing of the exhaust valve advanced at a preset point before top dead center; and the intake-side variable valve mechanism sets the opening timing of the intake valve retarded at a preset point after top dead center.

Even when the mechanical expansion ratio is set to the high mechanical expansion ratio point, this configuration serves to enhance the temperature of exhaust gas exhausted from the combustion chamber by sufficiently advancing the opening timing of the exhaust valve at engine start, and thereby early warm up and increase the conversion ratio of the exhaust gas purifying catalyst on the downstream side.

The present invention is not limited to the embodiments described above, but contains various modifications. For example, although the embodiments are detailed in order to better describe the invention, the invention is not limited to those having all of the features described above. Furthermore, a part of the features of one of the embodiments may be replaced with features of another one of the embodiments. Moreover, features of one of the embodiments may be added to the features of another one of the embodiments. A part of the features of each embodiment may be modified by addition of other features, or deleted, or replaced with other features.

### DESCRIPTION OF SYMBOLS

01 . . . Piston; 02 . . . Crankshaft; 03 . . . Connecting Rod Mechanism; 04 . . . Combustion Chamber; 05 . . . Ignition Plug; 1A . . . Intake-Side Variable Valve Mechanism; 1B . . . Exhaust-Side Variable Valve Mechanism; 2A, 2B . . . Phase Control Hydraulic Actuator; 3 . . . Variable Compression Ratio Mechanism; 4 . . . Intake Valve; 5 . . . Exhaust Valve; 2 . . . Controller; 49 . . . Compression Ratio Control Actuator; 72 . . . Throttle Valve.

1. An internal combustion engine variable operation system comprising:
an intake-side variable valve mechanism structured to control an opening timing and a closing timing of an intake valve of an internal combustion engine;
an exhaust-side variable valve mechanism structured to control an opening timing and a closing timing of an exhaust valve of the internal combustion engine; and
a controller configured to control the intake-side variable valve mechanism and the exhaust-side variable valve mechanism;
wherein at a cold start of the internal combustion engine,
the exhaust-side variable valve mechanism sets the opening timing of the exhaust valve advanced at or close to a midpoint between top dead center and bottom dead center, and sets the closing timing of the exhaust valve advanced at a first preset advance-side point before top dead center, and
the intake-side variable valve mechanism sets the opening timing of the intake valve retarded at a first preset retard-side point after top dead center.

2. The internal combustion engine variable operation system as claimed in claim 1, wherein the exhaust-side variable valve mechanism gradually retards the opening timing of the exhaust valve as a temperature of the internal combustion engine rises after the cold start.

3. The internal combustion engine variable operation system as claimed in claim 2, wherein the exhaust-side variable valve mechanism gradually retards the closing timing of the exhaust valve as the temperature of the internal combustion engine rises after the cold start.

4. The internal combustion engine variable operation system as claimed in claim 3, wherein:
when the internal combustion engine is in a low load region after the temperature of the internal combustion engine reaches a predetermined temperature point,
the exhaust-side variable valve mechanism sets the closing timing of the exhaust valve retarded at a second preset retard-side point after top dead center, and
the intake-side variable valve mechanism sets the opening timing of the intake valve retarded after top dead center so as to provide a positive valve overlap or a negative valve overlap between the opening timing of the intake valve and the closing timing of the exhaust valve, wherein the negative valve overlap is substantially equal to zero, and sets the closing timing of the intake valve retarded at or close to a midpoint between top dead center and bottom dead center.

5. The internal combustion engine variable operation system as claimed in claim 3, wherein:
when the internal combustion engine is in a high load region after the temperature of the internal combustion engine reaches a predetermined temperature point,
the exhaust-side variable valve mechanism sets the closing timing of the exhaust valve retarded at a third preset retard-side point after top dead center, and
the intake-side variable valve mechanism sets the opening timing of the intake valve advanced at a second preset advance-side point before top dead center so as to provide a positive valve overlap between the opening timing of the intake valve and the closing timing of the exhaust valve, and sets the closing timing of the intake valve advanced toward bottom dead center from proximity of a midpoint between top dead center and bottom dead center.

6. The internal combustion engine variable operation system as claimed in claim 1, further comprising:
a variable compression ratio mechanism structured to control a mechanical compression ratio and a mechanical expansion ratio of the internal combustion engine by variation in piston position of the internal combustion engine;
wherein the variable compression ratio mechanism controls the mechanical expansion ratio to a high mechanical expansion ratio point at the cold start; and
the high mechanical expansion ratio point is greater than a minimum mechanical expansion ratio point.

7. The internal combustion engine variable operation system as claimed in claim 1, wherein one or both of the intake-side variable valve mechanism and the exhaust-side variable valve mechanism includes an operating angle varying mechanism structured to adjust an operating angle.

8. An internal combustion engine variable operation system control device comprising:
an intake-side variable valve mechanism structured to control an opening timing and a closing timing of an intake valve of an internal combustion engine;
an exhaust-side variable valve mechanism structured to control an opening timing and a closing timing of an exhaust valve of the internal combustion engine; and
a controller configured to control the intake-side variable valve mechanism and the exhaust-side variable valve mechanism; wherein
the controller is further configured to perform a first function and a second function at a cold start of the internal combustion engine;
the first function is to control the exhaust-side variable valve mechanism to set the opening timing of the exhaust valve advanced at or close to a midpoint between top dead center and bottom dead center, and set the closing timing of the exhaust valve advanced at a first preset advance-side point before top dead center; and
the second function is to control the intake-side variable valve mechanism to set the opening timing of the intake valve retarded at a first preset retard-side point after top dead center.

9. The internal combustion engine variable operation system control device as claimed in claim 8, wherein the controller is further configured to perform a third function to control the exhaust-side variable valve mechanism to gradually retard the opening timing and the closing timing of the exhaust valve as a temperature of the internal combustion engine rises after the cold start.

10. The internal combustion engine variable operation system control device as claimed in claim 9, wherein:
the controller is further configured to perform a fourth function and a fifth function when the internal combustion engine is in a low load region after the temperature of the internal combustion engine reaches a predetermined temperature point;
the fourth function is to control the exhaust-side variable valve mechanism to set the closing timing of the exhaust valve retarded at a second preset retard-side point after top dead center; and
the fifth function is to control the intake-side variable valve mechanism to set the opening timing of the intake valve retarded after top dead center so as to provide a positive valve overlap or a negative valve overlap between the opening timing of the intake valve and the closing timing of the exhaust valve, wherein the negative valve overlap is substantially equal to zero, and set the closing timing of the intake valve retarded at or close to a midpoint between top dead center and bottom dead center.

11. The internal combustion engine variable operation system control device as claimed in claim 9, wherein:
the controller is further configured to perform a fourth function and a fifth function when the internal combustion engine is in a high load region after the temperature of the internal combustion engine reaches a predetermined temperature point;
the fourth function is to control the exhaust-side variable valve mechanism to set the closing timing of the exhaust valve retarded at a third preset retard-side point after top dead center; and
the fifth function is to control the intake-side variable valve mechanism to set the opening timing of the intake valve advanced at a second preset advance-side point before top dead center so as to provide a positive valve overlap between the opening timing of the intake valve and the closing timing of the exhaust valve, and set the closing timing of the intake valve advanced toward bottom dead center from proximity of a midpoint between top dead center and bottom dead center.

12. An internal combustion engine variable operation system control device comprising:
an intake-side variable valve mechanism structured to control an opening timing and a closing timing of an intake valve of an internal combustion engine;
an exhaust-side variable valve mechanism structured to control an opening timing and a closing timing of an exhaust valve of the internal combustion engine;
a variable compression ratio mechanism structured to control a mechanical compression ratio and a mechanical expansion ratio of the internal combustion engine by variation in piston position of the internal combustion engine; and
a controller configured to control the intake-side variable valve mechanism, the exhaust-side variable valve mechanism, and the variable compression ratio mechanism; wherein
the controller is further configured to perform a first function, a second function, and a third function at a cold start of the internal combustion engine; and
the first function is to control the variable compression ratio mechanism to set the mechanical expansion ratio to a high mechanical expansion ratio point, wherein the high mechanical expansion ratio point is greater than a minimum mechanical expansion ratio point;
the second function is to control the exhaust-side variable valve mechanism to set the opening timing of the exhaust valve advanced at or close to a midpoint between top dead center and bottom dead center, and set the closing timing of the exhaust valve advanced at a preset point before top dead center; and
the third function is to control the intake-side variable valve mechanism to set the opening timing of the intake valve retarded at a preset point after top dead center.
